(19) United States
(12) Patent Application Publication
(10) Pub. No.: US 2004/0259536 A1
(43) Pub. Date: Dec. 23, 2004

(54) Method, apparatus and system for enabling context aware notification in mobile devices

(76) Inventors: Dhananjay V. Keskar, Beaverton, OR (US); Brad Needham, North Plains, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/600,209

(22) Filed: Jun. 20, 2003

(51) Int. Cl. H04M 3/00

(52) U.S. Cl. 455/418

(57) ABSTRACT

Mobile devices may utilize various sensors to gather context information pertaining to the user's surroundings. These devices may also include and/or access other types of information pertaining to the user, such as the user's calendar data. In one embodiment, mobile devices may utilize some or all the gathered information to determine the appropriate behavior of the mobile device, in conjunction with the user's preferences.

### FIELD OF THE INVENTION

The present invention relates to the field of mobile computing, and, more particularly, to a method, apparatus and system for enabling mobile devices to be aware of the user's context and to automatically take appropriate action(s), if any, based on the user's preferences.

### BACKGROUND OF THE INVENTION

Use of mobile computing devices (hereafter “mobile devices”) such as laptops, notebook computers, personal digital assistants (“PDAs”) and cellular telephones (“cell phones”) is becoming increasingly popular today. The devices typically contain and/or have access to the users' calendar information, and users may carry these devices with them in various social and business contexts.

Mobile devices do not currently include any user context-awareness. For example, if a user is in a meeting, his cell phone has no way of automatically knowing that the user is busy and that the ringing of the cell phone during the meeting would be disruptive. Thus, typically, the user has to manually change the profile on his cellular telephone (e.g., “silent” or “vibrate”) before the meeting to ensure the ringing of the cell phone does not disrupt the meeting. The user must then remember to change the profile again after the meeting, to ensure that the ringing is once again audible.

### BRIEF DESCRIPTION OF THE DRAWINGS

The present invention is illustrated by way of example and not limitation in the figures of the accompanying drawings in which like references indicate similar elements, and in which:

FIG. 1 illustrates conceptually a mobile device including an embodiment of the present invention; and

FIG. 2 is a flow chart illustrating an embodiment of the present invention.

### DETAILED DESCRIPTION

Embodiments of the present invention provide a method, apparatus and system for enabling mobile devices to be aware of the user's context and to automatically take appropriate action(s), if any, based on explicit and/or derived information about the user's preferences.

Reference in the specification to “one embodiment” or “an embodiment” of the present invention means that a particular feature, structure or characteristic described in connection with the embodiment is included in at least one embodiment of the present invention. Thus, the phrases “in one embodiment”, “according to one embodiment” or the like appearing in various places throughout the specification are not necessarily all referring to the same embodiment.

As previously described, mobile devices currently do not possess any significant degree of user context awareness. Although there are laptop devices that may automatically adjust a computer monitor's backlight based on the ambient light surrounding the device, these devices do not have the ability to combine this physical context information with any other type of context information, and to further use the combined context information to alter the device's notification behavior. Similarly, there are devices that scroll images and/or text up and down when the device is tilted in either direction, but the devices are not “user context aware”, i.e., the devices behave the same for all users.

In various embodiments of the present invention, a variety of user context information may be gathered, processed and used to direct the mobile device to take appropriate action(s) automatically based on the user's preferences. Specifically, the user's context information may be gathered and/or accessed via a combination of sensors, information adapters and processing elements that take into account both the user's physical context (including the mobile device orientation, the ambient conditions and/or motion detection, hereafter referred to as “Physical Context” information) and the user's information context (including information from the user's calendar, the time of day and the user's location, hereafter referred to as “Other Context” information).

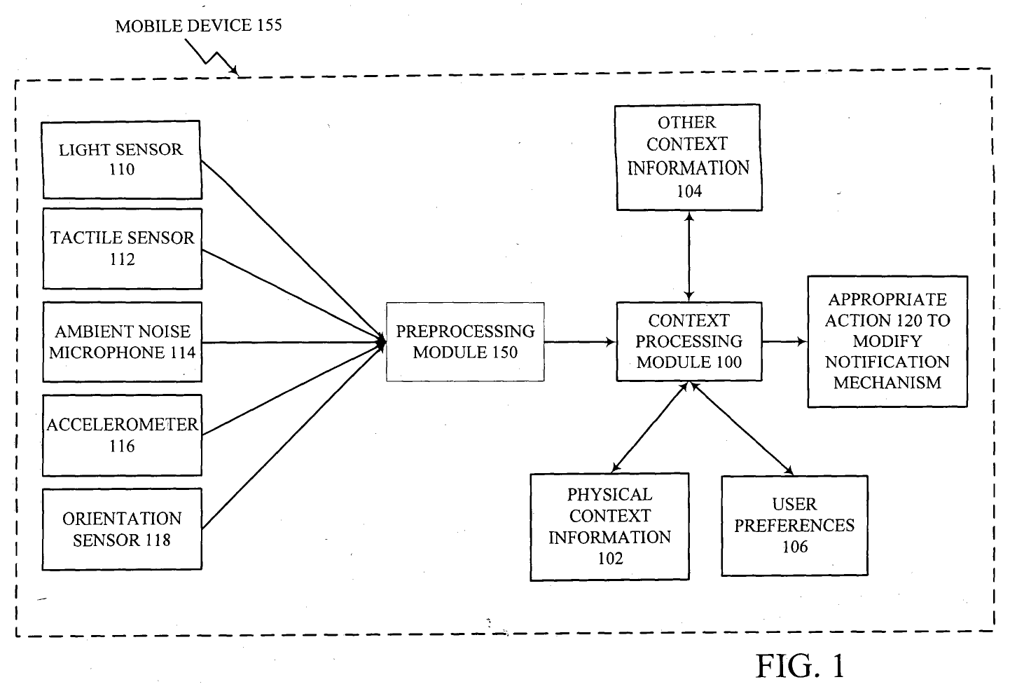

FIG. 1 illustrates conceptually a mobile device (“Mobile Device 155”) including an embodiment of the present invention. In order to determine the user's Physical Context 102, the mobile device may include one or more sensors. These sensors may gather a variety of context information pertaining to the user's physical surroundings. For example, Light Sensor 110 may be used to determine the level of ambient light surrounding the device, while Tactile Sensor 112 may determine whether the device is in contact with another object and/or surface. Similarly, Ambient Noise Microphone 114 may be used to determine the noise level surrounding the device, while Accelerometer 116 may determine whether the device is stationary or moving (and if moving, the speed at which the device is moving). Finally, Orientation Sensor 118 may keep track of the device orientation (e.g., face up, face down, right side up, etc.). In embodiments of the invention, each device may include one or more different types of sensors, as well as one or more of each type of sensor. It will be readily apparent to those of ordinary skill in the art that sensors other than the exemplary ones described above may be added to a mobile device, to gather additional context information without departing from the spirit of embodiments of the invention. It will additionally be apparent to those of ordinary skill in the art that existing sensors may be easily adapted to perform the above tasks.

In an embodiment of the present invention, as illustrated in FIG. 1, the information obtained by/from the sensors (Light Sensor 110, Tactile Sensor 112, Ambient Noise Microphone 114, Accelerometer 116, Orientation Sensor 118, etc.,) may be collected by a pre-processing module (“Preprocessing Module 150”). Preprocessing Module 150 may gather all the physical context information and determine an overall Physical Context 102 for the user. Thus, for example, based on information from Light Sensor 110 (e.g., low ambient light) and Accelerometer 116 (e.g., moving at 1 mile/hr), Preprocessing Module 150 may determine that Physical Context 102 for the device is that the device is within a contained space and that the contained space (e.g., a briefcase or even the user's pocket) is moving with the user. This Physical Context 102 information may then be used independently, or in conjunction with Other Context 104 (described further below) to determine Appropriate Action 120, if any, for the device.

In one embodiment, a context processing module (“Context Module 100”) may gather Other Context 104 from a number of different sources. For example, the user's daily schedule may be determined from the user's calendar (typically included in, and/or accessible by the user's mobile device). In addition to the user's scheduled meetings, access to the user's calendar may also provide location information, e.g., the user may be in New York for the day to attend a meeting. Additionally, location information (and other information) may also be obtained from device sensors and/or network-based providers. Date, day and time information may also easily be obtained from the mobile device and/or provided by the user's calendar.

According to embodiments of the present invention, Context Module 100 may use the collected information to determine overall Other Context 104 for the user. Then, in one embodiment, Context Module 100 may use Physical Information 102 and Other Context 104 independently, or in combination, to determine Appropriate Action 120 for the mobile device. It will be readily apparent to those of ordinary skill in the art that although Preprocessing Module 150 and Context Module 100 are described herein as separate modules, in various embodiments, these two modules may also be implemented as a single module without departing from the spirit of embodiments of the invention.

Furthermore, in one embodiment, the user may define actions to be taken by the mobile device for specified contexts (“User Preferences 106”). User Preferences 106 may be provided to Context Module 100, and together with Physical Context 102 information and/or Other Context 104 information, Context Module 100 may determine Appropriate Action 120 to be taken by the mobile device, if any. User Preferences 106 may specify the action that the user desires his mobile device to take under a variety of circumstances. In one embodiment, User Preferences 106 may specify that a mobile device should turn off all audible alerts when the device is placed in a certain orientation on a flat surface. For example, a user may take a PDA to a meeting and place it face down on the table. In this orientation, Context Module 100 may determine from all the gathered information (e.g., Physical Information 102, Other Context 104 and User Preferences 106) that the user desires the mobile device enter into a “silent” mode. Thus, Context Module 100 may inform the mobile device to turn off all audible alerts for the device, e.g., meeting reminders in Microsoft Outlook, message notifications, incoming call alerts, etc.

Conversely, when the user picks up his PDA and leaves the meeting, Context Module 100 may determine (e.g., based on the time of day and/or the user's motion, as indicated by one or more motion sensor(s)) that the meeting is over and turn the audible alerts back on. In one embodiment, if the user places the PDA in a carrying case, Context Module 100 may also determine (e.g., based on input from one or more light sensor(s) and/or ambient noise sensor(s)) that the PDA is in an enclosed space. Based on User Preference 106, Context Module 100 may therefore configure the mobile device to increase its alert level or its pitch (e.g., the loudness of the reminders within the PDA calendar program, or in the case of a cell phone, the loudness of the ringer). As will be readily apparent to those of ordinary skill in the art, the user may configure the behavior of the mobile device, to respond in predetermined ways to specified conditions.

User Preferences 106 may include the user's desired actions for different contexts. In one embodiment, mobile devices may include a default set of User Preferences 106. The mobile device may also include an interface to enable the user to modify this default set of preferences, to create customized User Preferences 106. In alternate embodiments, the mobile devices may not include any default preferences and the user may have to create and configure User Preferences 106. Regardless of the embodiment, however, the user may always configure a mobile device to take automatic action based on specific context information.

In one embodiment, in addition to, and/or instead of, preferences explicitly set by the user, User Preferences 106 may also comprise a list of preferences derived by Context Module 100, based on the user's typical behavior. For example, if the user does not explicitly set a preference for his PDA to turn all audible alerts off when placed face down, and instead manually turns off all audible alerts each time he enters a meeting and places his PDA face down, Context Module 100 may be configured to “learn” from the user's pattern of behavior that each time the PDA is placed face down, the device should be instructed to turn off all audible alerts. This type of “learning” behavior may be used independently and/or in conjunction with explicit preferences that the user may set. It will be readily apparent to those of ordinary skill in the art that the device's learning behavior may be configured by the user to ensure optimum functionality.

The embodiments described above rely on a combination of Physical Context 102 and Other Context 104, together with User Preferences 106 to determine Appropriate Action 120. It will be readily apparent, however, that Context Module 100 may be configured to receive and/or use as much or as little information as the user desires. As a result, Context Module 100 may occasionally use information gathered only from one or the other of Physical Context 102 and Other Context 104, and together with User Preferences 106, determine Appropriate Action 120. In one embodiment, Appropriate Action 120 may include one or more user context-aware notification behavior, e.g., turning on or off audible alerts on Mobile Device 155 at certain times and/or modifying the volume of alerts and/or ringers on Mobile Device 155 at other times. Other examples of Appropriate Action 120 may include causing Mobile Device 155 to enter a silent mode and/or a vibrate-only mode, emitting a beep from Mobile Device 155, causing a display screen on Mobile Device 155 to flash and causing a light emitting diode (“LED”) on Mobile Device 155 to blink.

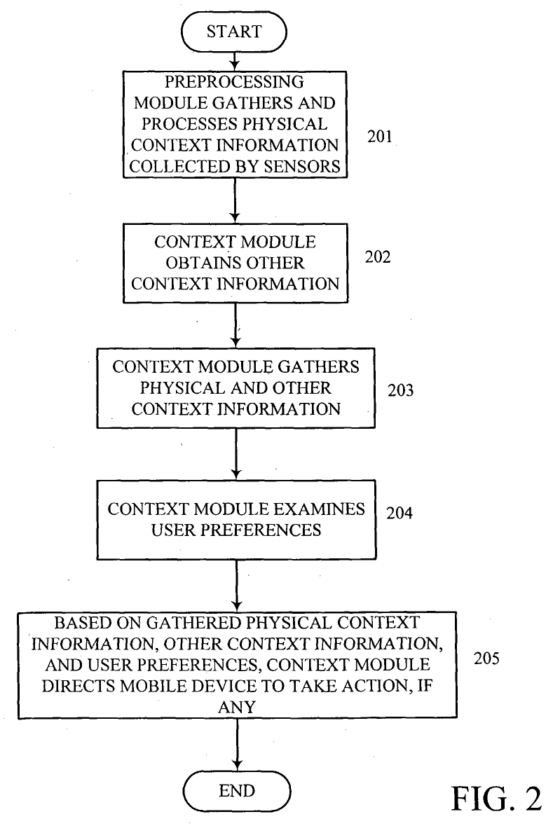

FIG. 2 is a flow chart illustrating an embodiment of the present invention. Although the following operations may be described as a sequential process, many of the operations may in fact be performed in parallel or concurrently. In addition, the order of the operations may be re-arranged without departing from the spirit of embodiments of the invention. In 201, information from the various sensors may be pre-processed to generate overall Physical Context information. In 202, the Context Module may gather this overall Physical Context information and the Other Context information, and in 203, the Context Module may process the Physical and Other Context information to determine an overall user context. In 204, the Context Module examines the user's preferences, and in 205,based on the overall user context, and the explicit or derived user preferences, the Context Module may direct the mobile device to take appropriate action, if any.

Embodiments of the present invention may be implemented on a variety of data processing devices. It will be readily apparent to those of ordinary skill in the art that these data processing devices may include various types of software, including Preprocessing Module 150 and Context Module 100. In various embodiments, Preprocessing Module 150 and Context Module 100 may comprise software, firmware, hardware or a combination of any or all of the above. According to an embodiment of the present invention, the data processing devices may also include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus host controller such as a Universal Serial Bus (“USB”) host controller may be coupled to the bus(es) and a plurality of devices may be coupled to the USB. For example, user input devices such as a keyboard and mouse may be included in the data processing device for providing input data. The data processing device may additionally include a variety of light emitting diode's (“LEDs”) that typically provide device information (e.g., the device's power status and/or other such information).

In the foregoing specification, the invention has been described with reference to specific exemplary embodiments thereof. It will, however, be appreciated that various modifications and changes may be made thereto without departing from the broader spirit and scope of embodiments of the invention, as set forth in the appended claims. The specification and drawings are, accordingly, to be regarded in an illustrative rather than a restrictive sense.

What is claimed is:

1. A method for enabling user context-aware notification in a mobile device, comprising:
gathering user context information from one or more sources;
processing the user context information; and
directing the mobile device to modify its notification behavior based on the user context information.

2. The method according to claim 1 wherein the notification behavior includes one of disabling the mobile device notification, lowering a volume of the mobile device notification, raising the volume of the mobile device notification, entering a silent mode, entering a vibrate-only mode, emitting a beep from the mobile device, causing a display screen on the mobile device to flash and causing a light emitting diode (“LED”) on the mobile device to blink.

3. The method according to claim 1 wherein gathering the user context information further comprises gathering physical context information and other context information.

4. The method according to claim 3 wherein gathering the physical context information includes gathering at least one of ambient light information, tactile information, ambient noise information, accelerometer information and orientation information.

5. The method according to claim 3 wherein gathering the other context information includes gathering at least one of a user calendar information, a user location, a time of day and a date.

6. The method according to claim 3 wherein gathering the user context information includes gathering the user context information from at least one of a light sensor, a tactile sensor, an ambient noise microphone, an accelerometer and an orientation sensor.

7. The method according to claim 3 wherein gathering the other context information includes gathering the other context information from at least one of a user calendar program and the mobile device.

8. The method according to claim 1 wherein processing the user context information further comprises processing a user preference with the user context information.

9. The method according to claim 1 wherein the user preferences include at least one of a default set of preferences, a customized set of preferences and a learned set of preferences.

10. An apparatus, comprising:
at least one module capable of gathering and processing user context information from one or more sources, the at least one module further capable of directing the mobile device to modify its notification behavior based on the user context information; and
a notification mechanism capable of modification based on the user context information.

11. The apparatus according to claim 10 wherein the at least one module is further capable of gathering physical context information and other context information.

12. The apparatus according to claim 11 wherein the at least one module is further capable of gathering at least one of light information, tactile information, ambient noise information, accelerometer information and orientation information.

13. The apparatus according to claim 11 wherein the at least one module is further capable of gathering at least one of a user calendar information, a user location, a time of day and a date.

14. The apparatus according to claim 11 further comprising at least one of:
a light sensor;
a tactile sensor;
an ambient noise microphone;
an accelerometer; and
an orientation sensor.

15. The apparatus according to claim 10 wherein the at least one module is capable of processing a user preference with the context information.

16. The apparatus according to claim 10 wherein the at least one module comprises a preprocessing module and a context processing module.

17. An article comprising a machine-accessible medium having stored thereon instructions that, when executed by a machine, cause the machine to:
gather user context information from one or more sources;
process the user context information; and
direct the mobile device to modify its notification behavior based on the user context information.

18. The article according to claim 17 wherein the instructions, when executed by the machine, further cause the machine to direct the mobile device to perform at least one of disabling the mobile device notification, lowering the volume of the mobile device notification and raising the volume of the mobile device notification.

19. The article according to claim 18 wherein the instructions, when executed by the machine, further cause the machine to gather physical context information and other context information.

20. The article according to claim 19 wherein the instructions, when executed by the machine, further cause the machine to gather at least one of light information, tactile information, ambient noise information, accelerometer information and orientation information.

21. The article according to claim 19 wherein the instructions, when executed by the machine, further cause the machine to gather at least one of a user calendar information, a user location, a time of day and a date.

22. The article according to claim 19 wherein the instructions, when executed by the machine, further cause the machine to gather the user context information from at least one of a light sensor, a tactile sensor, an ambient noise microphone, an accelerometer and an orientation sensor.

23. The article according to claim 19 wherein the instructions, when executed by the machine, further cause the machine to gather the other context information from at least one of a user calendar program and the mobile device.

24. The article according to claim 17 wherein the instructions, when executed by the machine, further cause the machine to process a user preference with the user context information.
